(19) United States
(12) Patent Application Publication
(10) Pub. No.: US 2007/0159587 A1
(43) Pub. Date: Jul. 12, 2007

(54) Display panel with improved side views

(75) Inventors: Dong-Gyu Kim, Yongin-si (KR); Won-Hee Lee, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/649,955

(22) Filed: Jan. 5, 2007

(30) Foreign Application Priority Data
Jan. 6, 2006 (KR) 2006-1898

(51) Int. Cl. G02F 1/1339

(52) U.S. Cl. 349/144

(57) ABSTRACT

A display panel that provides improved display quality when viewed from the sides is presented. The display panel includes a first display substrate and a second display substrate facing the first display substrate. The first display substrate has a first base substrate, a thin film transistor, a main pixel electrode and a sub pixel electrode. The first base substrate includes a pixel area divided into a main pixel area and a sub pixel area. The thin film transistor is formed on the first base substrate and the main pixel electrode is electrically connected to a drain electrode of the thin film transistor. The sub pixel electrode has the same shape as the main pixel electrode and is electrically connected to the main pixel electrode. Also, the sub pixel electrode is electrically insulated from and overlaps the drain electrode. Thus, a difference between a left side viewing angle and a right side viewing angle of the display panel is reduced, thereby improving the overall display quality of the display panel.

### CROSS-REFERENCE TO RELATED APPLICATION

This application relies for priority upon Korean Patent Application No. 2006-01898 filed on Jan. 6, 2006, the content of which is herein incorporated by reference in its entirety.

### BACKGROUND OF THE INVENTION

1. Field of the Invention

The present invention relates to a display panel. More particularly, the present invention relates to a super-patterned vertical alignment (S-PVA) mode liquid crystal display panel.

2. Description of the Related Art

Generally, a liquid crystal display device includes an array substrate, a color filter substrate positioned parallel to the array substrate, and a liquid crystal layer interposed between the array substrate and the color filter substrate.

The array substrate includes a plurality of pixels that can be selectively activated to display an image. Each of the pixels includes a gate line, a data line, a thin film transistor and a pixel electrode. The gate line receives a gate signal and is electrically connected to a gate electrode of the thin film transistor. The data line receives a data signal and is electrically connected to a source electrode of the thin film transistor. The pixel electrode is electrically connected to a drain electrode of the thin film transistor. The pixel electrode and the common electrode are positioned substantially parallel to each other and sandwich the liquid crystal layer between them. The common electrode is formed on the color filter substrate.

In comparison with a cathode ray tube type display device, the liquid crystal display device has numerous advantages including thinness. However, it also has a disadvantage such as a narrow viewing angle.

In order to widen the viewing angle of the liquid crystal display device, recently, a liquid crystal display device employing various modes, for example, such as a patterned vertical alignment (PVA) mode, a multi-domain vertical alignment (MVA) mode, a super-patterned vertical alignment (S-PVA) mode, etc., has been researched and developed.

Especially, the S-PVA mode liquid crystal display device includes a main pixel electrode and a sub pixel electrode in one pixel area to form at least two domains having different gray values in the one pixel area. For the different gray values in the one pixel area, the main and sub pixel electrodes receive different voltages.

However, in the S-PVA mode liquid crystal display device, a structure of the one pixel having the main pixel electrode and the sub pixel electrode is complicated. As a result, when layers or substrates for the S-PVA mode liquid crystal display device are misaligned with each other, spots occur on the liquid crystal display device, thereby causing deterioration of display quality in the S-PVA mode liquid crystal display device.

### SUMMARY OF THE INVENTION

The present invention provides a display panel having improved views from the side.

In one aspect, the present invention is a display panel that includes a first display substrate and a second display substrate positioned substantially parallel to the first display substrate. The first display substrate includes a first base substrate, a thin film transistor, a main pixel electrode and a sub pixel electrode. The first base substrate includes a pixel area divided into a main pixel area and a sub pixel area adjacent to the main pixel area. The thin film transistor is formed on the first base substrate. The main pixel electrode is formed in the main pixel area and electrically connected to a drain electrode of the thin film transistor. The sub pixel electrode is formed in the sub pixel area and electrically connected to the main pixel electrode. The sub pixel electrode has the same shape as the main pixel electrode and overlaps the drain electrode.

In another aspect, the display panel includes a first display substrate and a second display substrate facing the first display substrate.

The first display substrate includes a first base substrate, a first thin film transistor, a second thin film transistor, a main pixel electrode and a sub pixel electrode. The first base substrate includes a pixel area divided into a main pixel area and a sub pixel area adjacent to the main pixel area. The first and second thin film transistors, which have first and second drain electrodes, respectively, are formed on the first base substrate. The main pixel electrode is formed in the main pixel area and electrically connected to the first thin film transistor. The sub pixel electrode is formed in the sub pixel area. The sub pixel electrode is electrically insulated from the main pixel electrode and connected to the second drain electrode. The sub pixel electrode has the same shape as the main pixel electrode.

In the invention, as the main pixel electrode in the main pixel area has the same size and shape as the sub pixel electrode in the sub pixel area, occurrence of spots in the display that is often caused by misalignment of the first substrate and the second substrate is reduced. Thus, overall display quality is improved.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view showing an exemplary embodiment of a super-patterned vertical alignment mode liquid crystal display panel according to the present invention;

FIG. 2 is a cross-sectional view taken along the line I-I′ of FIG. 1;

FIG. 3 is an equivalent circuit diagram of the liquid crystal display panel shown in FIG. 1;

FIG. 4 is a plan view showing another exemplary embodiment of a super-patterned vertical alignment mode liquid crystal display panel according to the present invention;

FIG. 5 is a cross-sectional view taken along the line II-II′ of FIG. 4;

FIG. 6 is an equivalent circuit diagram of the liquid crystal display panel shown in FIG. 4;

FIG. 7 is a plan view showing another exemplary embodiment of a super-patterned vertical alignment mode liquid crystal display panel according to the present invention;

FIG. 8 is a cross-sectional view taken along the line III-III′ of FIG. 7; and

FIG. 9 is an equivalent circuit diagram of the liquid crystal display panel shown in FIG. 7.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

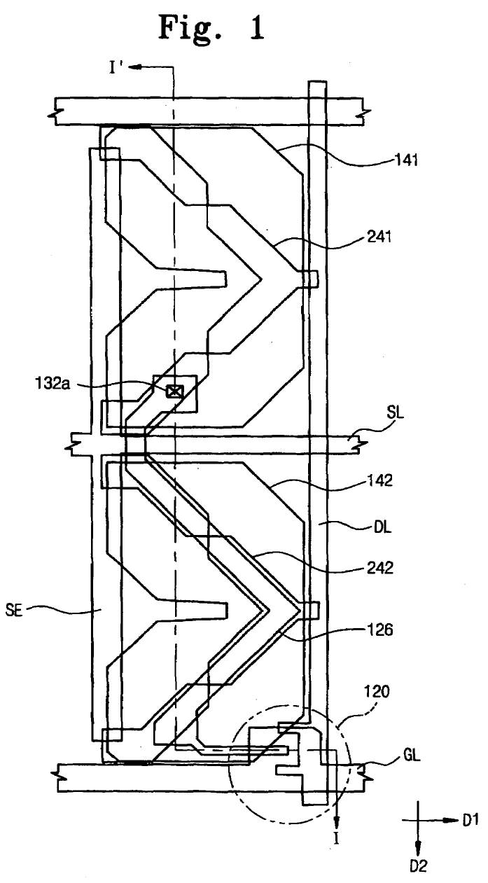

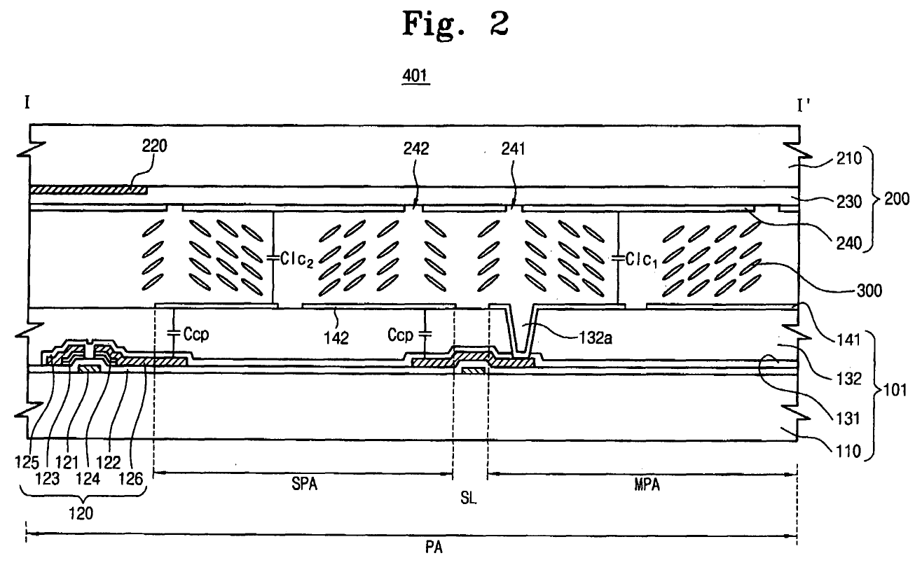

FIG. 1 is a plan view showing an exemplary embodiment of a super-patterned vertical alignment mode liquid crystal display panel according to the present invention. FIG. 2 is a cross-sectional view taken along the line I-I′ of FIG. 1.

Referring to FIGS. 1 and 2, a super-patterned vertical alignment (S-PVA) mode liquid crystal display panel 401 includes an array substrate 101, a color filter substrate 200 facing the array substrate 101 and a liquid crystal layer 300 interposed between the array substrate 101 and the color filter substrate 200.

The array substrate 101 includes a first base substrate 110, a thin film transistor 120, a main pixel electrode 141 and a sub pixel electrode 142.

The first base substrate 110 includes a pixel area PA which is divided into a main pixel area MPA and a sub pixel area SPA. The pixel area PA is defined by a gate line GL extending in a first direction D1 and a data line DL extending in a second direction D2 substantially perpendicular to the first direction D1. The gate line GL is formed on a different layer from the data line DL, so that the gate line GL extends perpendicularly to but is insulated from the data line DL.

The thin film transistor 120 is formed in the pixel area PA adjacent to the sub pixel area SPA. The thin film transistor 120 includes a gate electrode 121 that branches from the gate line GL, a source electrode 125 that branches from the data line DL and a drain electrode 126 spaced apart from the source electrode 125 and extending in the sub pixel area SPA. After forming the gate electrode 121 and the gate line GL on the first base substrate 110, a gate insulating layer 122 is formed on the first base substrate 110 to cover the gate electrode 121 and the gate line GL. An active layer 123 and an ohmic contact layer 124 are formed on the gate insulating layer 122 corresponding to the gate electrode 121. The source electrode 125 and the drain electrode 126 are formed on the ohmic contact layer 124. The drain electrode 126 extends in the sub pixel area SPA and bends into the first direction D1 to have a V-shape.

The array substrate 101 further includes a storage line SL formed between the sub pixel area SPA and the main pixel area MPA. The storage line SL is formed on the first base substrate 110 with the gate line GL and extends in the first direction D1. The array substrate 101 further includes a storage electrode SE that branches out from the storage line SL to extend in the second direction D2.

The thin film transistor 120 is covered by a passivation layer 131 and an organic insulating layer 132. The passivation layer 131 includes a silicon nitride layer (SiNx) or a silicon oxide layer (SiOx), and the organic insulating layer 132 includes an acrylic-containing resin.

The main pixel electrode 141 is formed on the organic insulating layer 132 in the main pixel area MPA, and the sub pixel electrode 142 is formed on the organic insulating layer 132 in the sub pixel area SPA. In the present embodiment, the main pixel electrode 141 may have the same shape and size the sub pixel electrode 142. Also, although the main and sub pixel electrodes 141 and 142 generally extend substantially parallel to the data line DL, they have cutouts that extend in the first direction D1 parallel to the gate line GL. The main and sub pixel electrodes 141 and 142 may be made of a transparent conductive material such as indium tin oxide (ITO), indium zinc oxide (IZO), etc.

The main pixel electrode 141 and the sub pixel electrode 142 partially overlap the storage electrode SE. The main pixel electrode 141 and the storage electrode SE form a first storage capacitor Cst1, and the sub pixel electrode 142 and the storage electrode SE form a second storage capacitor Cst2.

The sub pixel electrode 142 is parallel to and partially overlap the drain electrode 126, and the passivation layer 131 and the organic insulating layer 132 are formed between the sub pixel electrode 142 and the drain electrode 126. The sub pixel electrode 142 and the drain electrode 126 form a coupling capacitor Ccp.

The main pixel electrode 141 is electrically connected to the drain electrode 126 in the main pixel area MPA. Particularly, the drain electrode 126 extends to a corner of the main pixel area MPA through the sub pixel area SPA and the storage line SL. The passivation layer 131 and the organic insulating layer 132 have a contact hole 132a through which the drain electrode 126 formed in the main pixel area MPA is exposed. Thus, the main pixel electrode 141 is electrically connected to the drain electrode 126 through the contact hole 132a.

The color filter substrate 200 includes a second base substrate 210, a black matrix 220, a color filter layer 230 and a common electrode 240.

The black matrix 220 may be made of a metal material such as chromium (Cr), chromium trioxide (Cr2O3), etc., and is formed on the parts of the second base substrate 210 that overlap the gate line GL, the data line DL and the thin film transistor 120. The color filter layer 230 includes a red color pixel, a green color pixel and a blue color pixel and is formed on the second base substrate 210. The common electrode 240 includes a transparent conductive material, such as ITO or IZO, and is uniformly formed on the color filter layer 230.

The common electrode 240 is partially removed to form a first opening 241 and a second opening 242 corresponding to the main and sub pixel areas MPA and SPA, respectively. As shown in FIG. 1, the first and second openings 241 and 242 are formed at a center portion of the main and sub pixel areas MPA and SPA and have generally a V-shape. Thus, the location of the second opening 242 formed in the sub pixel electrode SPA corresponds to the location of the drain electrode 126.

The liquid crystal layer 300 having a plurality of liquid crystal molecules is disposed between the array substrate 101 and the color filter substrate 200. Eight domains, each of which has the liquid crystal molecules aligned in a particular direction, form in the pixel area PA due to the presence of the common electrode 240, the main pixel electrode 141, and the sub pixel electrode 142. Especially, each of the main and sub pixel areas MPA and SPA includes four domains. In the present embodiment, each of the domains may have a maximum width of about 20 micrometers. Thus, when manufacturing the liquid crystal display panel 401, a misalignment margin between the array substrate 101 and the color filter substrate 200 may not be greater than about 6 micrometers to about 7 micrometers.

The common electrode 240 and the main pixel electrode 141 form a first liquid crystal capacitor Clc1, and the common electrode 240 and the sub pixel electrode 142 form a second liquid crystal capacitor Clc2. The second liquid crystal capacitor Clc2 is charged by a lower voltage than that of the first liquid crystal capacitor Clc1 due to the coupling capacitor Ccp. Thus, the liquid crystal molecules in the sub pixel area SPA are inclined toward the array substrate 101 less drastically than that of the liquid crystal molecules in the main pixel area MPA. As a result, the liquid crystal display panel 401 may improve the side viewing angle of the panel without compromising brightness viewed from the front of the panel. The brightness as viewed from the front is not decreased because light passing through the main pixel area MPA and light passing through the sub pixel area SPA are combined.

Further, the main pixel electrode 141 has the same size and shape as the sub pixel electrode 142, and the main and sub pixel electrodes 141 and 142 are symmetrical with respect to the storage line SL, as shown in FIG. 1. Thus, although misalignment may occur during the assembling process for the array substrate 101 and the color filter substrate 200 of the liquid crystal display panel 401, variation in capacitance caused by differences among the domains of the main pixel area MPA substantially tracks the variation of the capacitance in the sub pixel area SPA. As a result, the liquid crystal display panel 401 is able to prevent occurrence of spots and improve the overall display quality.

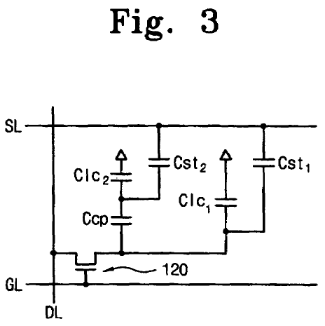

FIG. 3 is an equivalent circuit diagram of the liquid crystal display panel shown in FIG. 1.

Referring to FIG. 3, the liquid crystal display panel 401 includes the thin film transistor 120 electrically connected to the gate line GL and the data line DL, the first liquid crystal capacitor Clc1, and the second liquid crystal capacitor Clc2. As shown, the second liquid crystal capacitor Clc2 is connected to the first liquid crystal capacitor Clc1 in parallel. The thin film transistor 120 includes a gate electrode electrically connected to the gate line GL, a source electrode electrically connected to the data line DL and a drain electrode electrically connected to the first liquid crystal capacitor Clc1. The first storage capacitor Cst1, which is electrically connected to the storage line SL, is connected to the first liquid crystal capacitor Clc1 in parallel, and the second storage capacitor Cst2 is connected to the second liquid crystal capacitor Clc2 in parallel.

The coupling capacitor Ccp that is electrically connected to the drain electrode of the thin film transistor 120 is connected to the second liquid crystal capacitor Clc2 in series.

When the gate voltage is applied to the gate line GL, the thin film transistor 120 is turned on, so that the data voltage applied to the data line DL is outputted to the drain electrode. The data voltage is applied to the main pixel electrode 141 of the first liquid crystal capacitor Clc1 to charge the first liquid crystal capacitor Clc1. The voltage charged into the second liquid crystal capacitor Clc2 by the coupling capacitor Ccp is lower than the voltage that is charged into the first liquid crystal capacitor Clc1.

Thus, the liquid crystal molecules in the sub pixel area SPA are inclined toward the array substrate 101 to a less degree than the liquid crystal molecules in the main pixel area MPA. As a result, the viewing angle of the liquid crystal display panel 401 is increased without compromising the brightness from the front. The brightness as viewed from the front is not decreased because light passing through the main pixel area MPA and light passing through the sub pixel area SPA are combined.

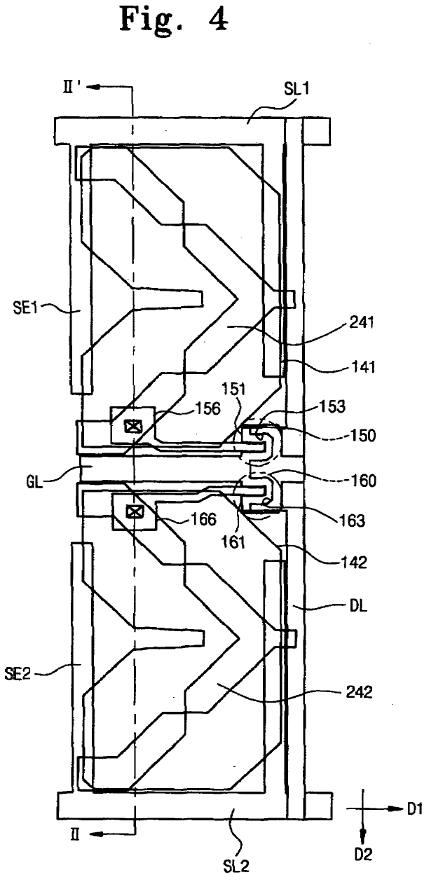

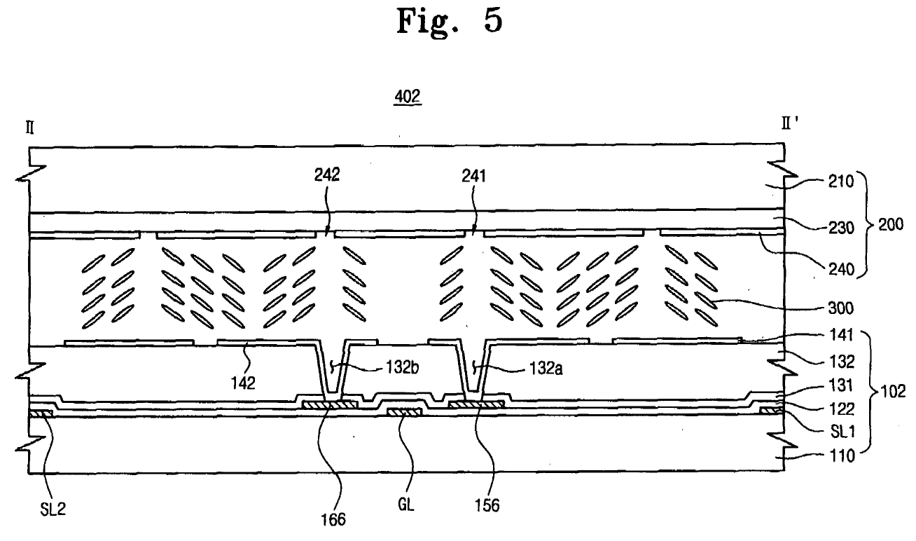

FIG. 4 is a plan view showing another exemplary embodiment of a super-patterned vertical alignment mode liquid crystal display panel according to the present invention. FIG. 5 is a cross-sectional view taken along the line II-II′ of FIG. 4. In FIGS. 4 and 5, same reference numerals denote the same elements as in FIGS. 1 and 2, and thus redundant descriptions will be omitted.

Referring to FIGS. 4 and 5, in an S-PVA mode liquid crystal display panel 402 according to another exemplary embodiment of the present invention, an array substrate 102 includes the first base substrate 110, a first thin film transistor 150, a second thin film transistor 160, a main pixel electrode 141 and a sub pixel electrode 142.

The first base substrate 110 includes the gate line GL formed thereon that extends in the first direction D1 and the data line DL formed thereon that extends in the second direction D2. The gate line GL is formed between the main pixel area MPA and the sub pixel area SPA.

The first thin film transistor 150 is formed at a position adjacent to the main pixel area MPA and the second thin film transistor 160 is formed at a position adjacent to the sub pixel area SPA. Gate electrodes 151 and 161 of the first and second thin film transistors 150 and 160 branch out from the gate line GL, and source electrodes 153 and 163 of the first and second thin film transistors 150 and 160 branch from the data line DL. The drain electrode 156 of the first thin film transistor 150 extends to the main pixel area MPA and the drain electrode 166 of the second thin film transistor 160 extends to the sub pixel area SPA.

The array substrate 102 further includes first and second storage lines SL1 and SL2 which extend in the first direction D1. The first storage line SL1 is formed at a position adjacent to the main pixel area MPA and the second storage line SL2 is formed at a position adjacent to the sub pixel area SPA. A first storage electrode SE1 branches out from the first storage line SL1 and extends toward the gate line GL, and a second storage electrode SE2 branches out from the second storage line SL2 and extends toward the gate line GL. The first and second storage electrodes SE1 and SE2 extend substantially parallel to the data line DL.

The first and second thin film transistors 150 and 160 are covered by a passivation layer 131 and an organic insulating layer 132 sequentially formed on the first and second thin film transistors 150 and 160. The passivation layer 131 and the organic insulating layer 132 are partially removed to form first and second contact holes 132a and 132b through which the drain electrodes of the first and second thin film transistors 150 and 160 are exposed, respectively.

The main pixel electrode 141 is formed on a part of the organic insulating layer 132 in the main pixel area MPA and the sub pixel electrode 142 is formed on a part of the organic insulating layer 132 in the sub pixel area SPA. The main pixel electrode 141 is electrically connected to the drain electrode 156 of the first thin film transistor 150 through the first contact hole 132a. The sub pixel electrode 142 is electrically connected to the drain electrode 166 of the second thin film transistor 160 through the second contact hole 132b.

In the present embodiment, the main pixel electrode 141 may have the same shape and size as as the sub pixel electrode 142. Also, the main and sub pixel electrodes 141 and 142 each has one side that is substantially parallel to the data line DL and another side that has a cutout extending in the direction of the gate line GL.

The main pixel electrode 141 and the sub pixel electrode 142 partially overlap the first storage electrode SE1 and the second storage electrode SE2, respectively. The main pixel electrode 141 and the first storage electrode SE1 form a first storage capacitor Cst1, and the sub pixel electrode 142 and the second storage electrode SE2 form a second storage capacitor Cst2.

Further, the main pixel electrode 141 having same size and shape as in those of the sub pixel electrode 142 is formed in the main pixel area MPA and the sub pixel electrode 142 is formed in the sub pixel area SPA. Also, the main and sub pixel electrodes 141 and 142 are symmetrically positioned with respect to the gate line GL when seen in plan view (see FIG. 4). Thus, although the array substrate 102 and the color filter substrate 200 of the liquid crystal display panel 402 may be misaligned during assembly, any variation in capacitance caused by differences among the domains of the main pixel area MPA substantially tracks the variation in capacitance in the sub pixel area SPA. As a result, there is no spot formation in the liquid crystal display panel 402 and the overall display quality is improved.

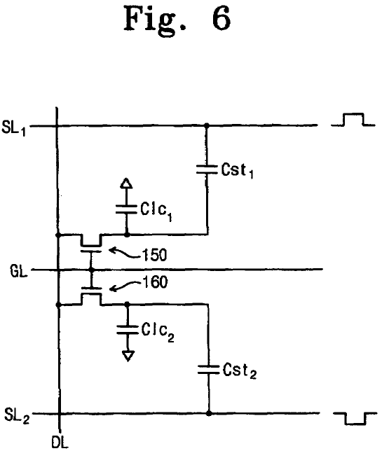

FIG. 6 is an equivalent circuit diagram of the liquid crystal display panel shown in FIG. 4.

Referring to FIG. 6, the liquid crystal display panel 402 includes the first and second thin film transistors 150 and 160 electrically connected to the data line DL, and first and second liquid crystal capacitors Clc1 and Clc2 electrically connected to the first and second thin film transistors 150 and 160, respectively.

The liquid crystal display panel 402 further includes a first storage capacitor Cst1 connected to the first liquid crystal capacitor Clc1 in parallel and a second storage capacitor Cst2 connected to the second liquid crystal capacitor Clc2 in parallel.

Responsive to the gate voltage applied to the gate line GL, the first and second thin film transistors 150 and 160 are turned on to charge the first and second liquid crystal capacitors Clc1 and Clc2 by the data voltage applied to the data line DL. A first storage voltage and a second storage voltage having a different voltage level from the first storage voltage are applied to the first and second storage lines SL1 and SL2 while the first and second liquid crystal capacitors Clc1 and Clc2 are charged by the data voltage. In the present embodiment, the first and second storage voltages may have different polarities from each other.

Due to the different polarities of the first and second storage voltages, the first storage capacitor Cst1 is charged with a different voltage from the second storage capacitor Cst2. For example, the second liquid crystal capacitor Clc2 may be charged to a lower voltage level than the first liquid crystal capacitor Clc1. This way, the liquid crystal molecules in the sub pixel area SPA are inclined toward the array substrate 101 to a lesser degree than the liquid crystal molecules in the main pixel area MPA. Thus, the liquid crystal display panel 401 has an improved side view and a broader viewing angle without compromising brightness from the front. The brightness as viewed from the front is not decreased because light passing through the main pixel area MPA and light passing through the sub pixel area SPA are combined.

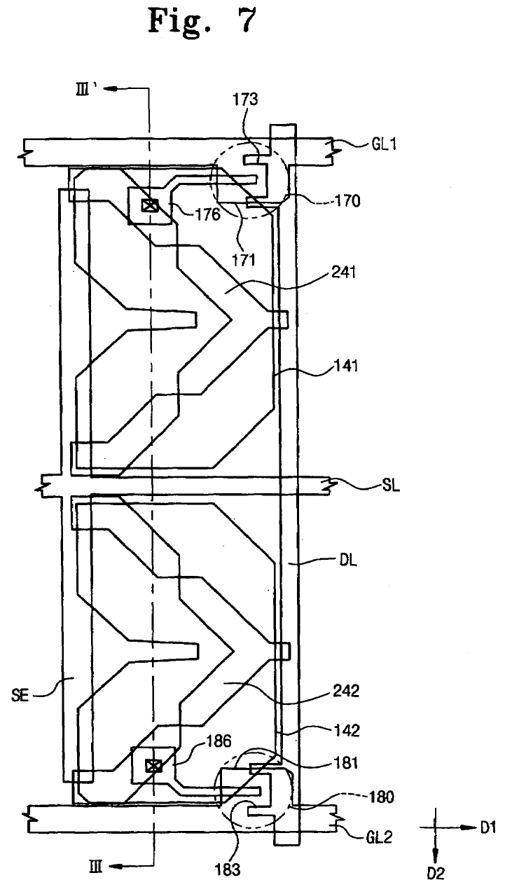

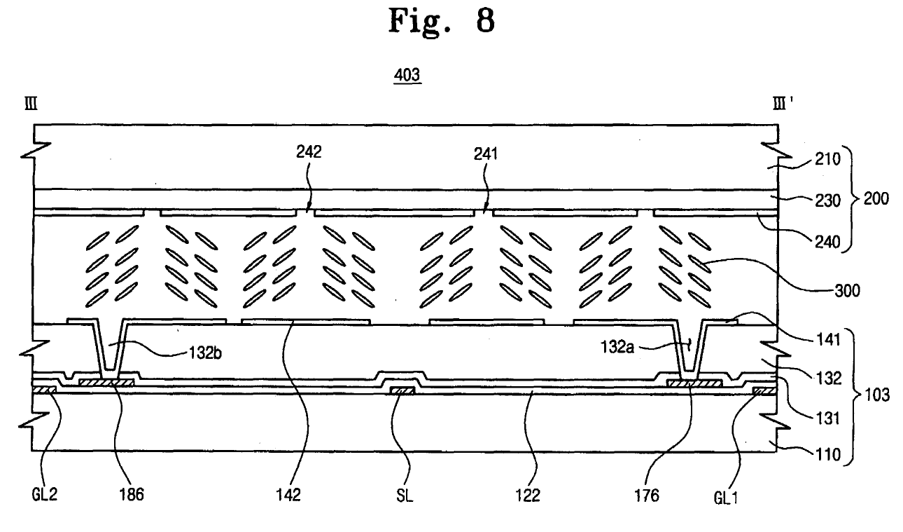

FIG. 7 is a plan view showing another exemplary embodiment of a super-patterned vertical alignment mode liquid crystal display panel according to the present invention. FIG. 8 is a cross-sectional view taken along the line III-III′ of FIG. 7. In FIGS. 7 and 8, the same reference numerals denote the same elements in FIGS. 1 and 2, and any redundant description will be omitted.

Referring to FIGS. 7 and 8, in an S-PVA mode liquid crystal display panel 403 according to another exemplary embodiment of the present invention, an array substrate 103 includes the first base substrate 110, a first thin film transistor 170, a second thin film transistor 180, the main pixel electrode 141 and the sub pixel electrode 142.

The first base substrate 110 includes first and second gate lines GL1 and GL2 formed thereon that extend in a first direction D1 and a data line DL formed thereon that extends in a second direction D2.

The first thin film transistor 170 is formed at a position adjacent to the main pixel area MPA and the second thin film transistor 180 is formed at a position adjacent to the sub pixel area SPA. Gate electrodes 171 and 181 of the first and second thin film transistors 170 and 180 branch out from the first and second gate lines GL1 and GL2, respectively. Source electrodes 173 and 183 of the first and second thin film transistors 170 and 180 branch out from the data line DL. The drain electrode 176 of the first thin film transistor 170 extends into the main pixel area MPA and the drain electrode 186 of the second thin film transistor 180 extends into the sub pixel area SPA.

The array substrate 103 further includes a storage line SL that extends in the first direction D1 substantially parallel to the first and second gate lines GL1 and GL2. The storage line SL is formed between the main pixel area MPA and the sub pixel area SPA. A storage electrode SE branches out from the storage line SL and extends in the second direction D2 that is substantially parallel to the data line DL.

The first and second thin film transistors 170 and 180 are covered by a passivation layer 131 and an organic insulating layer 132 that are sequentially formed on the array substrate 103. The first and second thin film transistors 170 and 180 are also formed on the array substrate 103. The passivation layer 131 and the organic insulating layer 132 are partially removed to form first and second contact holes 132a and 132b that extend to the drain electrodes 176 and 186 of the first and second thin film transistors 170 and 180, respectively.

The main pixel electrode 141 is formed on a part of the organic insulating layer 132 in the main pixel area MPA and the sub pixel electrode 142 is formed on a part of the organic insulating layer 132 in the sub pixel area SPA. The main pixel electrode 141 is electrically connected to the drain electrode 176 of the first thin film transistor 170 through the first contact hole 132a. The sub pixel electrode 142 is electrically connected to the drain electrode 186 of the second thin film transistor 180 through the second contact hole 132b.

The main pixel electrode 141 and the sub pixel electrode 142 partially overlap the storage electrode SE. The main pixel electrode 141 and the storage electrode SE form a first storage capacitor Cst1, and the sub pixel electrode 142 and the storage electrode SE form a second storage capacitor Cst2.

In the present embodiment, the main pixel electrode 141 may have the same shape and size as the sub pixel electrode 142. Further, the main and sub pixel electrodes 141 and 142 are symmetrically positioned with respect to the gate line GL. Thus, although the array substrate 103 and the color filter substrate 200 of the liquid crystal display panel 403 may be misaligned during assembly, any variation in capacitance caused by differences among the domains of the main pixel area MPA substantially tracks the variation in capacitance in the sub pixel area SPA. As a result, there is no spot formation in the liquid crystal display panel 403 and the overall display quality is improved.

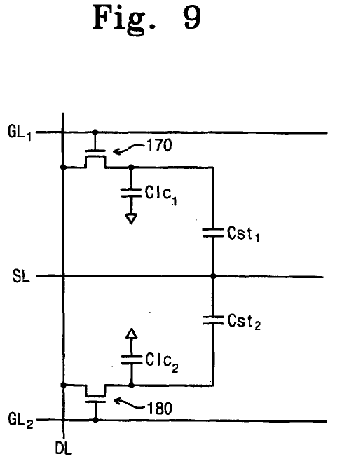

FIG. 9 is an equivalent circuit diagram of the liquid crystal display panel shown in FIG. 7.

Referring to FIG. 9, the liquid crystal display panel 403 includes the first thin film transistor 170 electrically connected to the first gate line GL1 and the data line DL, and the second thin film transistor 180 electrically connected to the second gate line GL2 and the data line DL. The liquid crystal display panel 403 further includes a first liquid crystal capacitor Clc1 electrically connected to the first thin film transistor 170 and a second liquid crystal capacitor Clc2 electrically connected to the second thin film transistor 180. In the present embodiment, the first storage capacitor Cst1 is connected to the first liquid crystal capacitor Clc1 in parallel, and the second storage capacitor Cst2 is connected to the second liquid crystal capacitor Clc2 in parallel.

As used herein, “H” indicates the amount of time taken to drive one pixel. During the first H/2 period, a first gate voltage is applied to the first gate line GL1 to drive the first thin film transistor 170. During the second H/2 period, a second gate voltage is applied to the second gate line GL2 to drive the second thin film transistor 180. When the first thin film transistor 170 is turned on in response to the first gate voltage, the first liquid crystal capacitor Clc1 is charged by a first data voltage applied to the data line DL. Then, when the second thin film transistor 180 is turned on in response to the second gate voltage, the second liquid crystal capacitor Clc2 is charged by a second data voltage that is applied to the data line DL and lower than the first data voltage.

In the present embodiment, the second liquid crystal capacitor Clc2 is charged with a lower voltage than the first liquid crystal capacitor Clc1. Thus, the liquid crystal molecules in the sub pixel area SPA are inclined toward the array substrate 101 to a lesser degree than the liquid crystal molecules in the main pixel area MPA. Thus, the liquid crystal display panel 401 has an improved side view and a wider viewing angle without compromising brightness from front. The brightness as viewed from the front is not decreased because light passing through the main pixel area MPA and light passing through the sub pixel area SPA are combined.

According to the liquid crystal display panel, the main pixel electrode and the sub pixel electrode are symmetrically arranged with respect to the storage line SL. That is, the main pixel electrode in the main pixel area has the same size and shape as the sub pixel electrode in the sub pixel area. Thus, although the array substrate and the color filter substrate may be misaligned during assembly, the number of spots on the liquid crystal display panel is significantly reduced and the overall display quality is improved.

Further, since the main pixel electrode in the main pixel area has the same size and shape as the sub pixel electrode in the sub pixel area, the domains in the main and sub pixel areas may have a width over 20 micrometers. This improves the yield in the manufacturing process of the liquid crystal display panel.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display panel comprising:
a first display substrate; and
a second display substrate facing the first display substrate,
wherein the first display substrate comprises:
a first base substrate including a pixel area divided into a main pixel area and a sub pixel area adjacent to the main pixel area;
a thin film transistor formed on the first base substrate;
a main pixel electrode formed in the main pixel area and electrically connected to a drain electrode of the thin film transistor; and
a sub pixel electrode formed in the sub pixel area and electrically connected to the main pixel electrode, the sub pixel electrode having a same shape as the main pixel electrode and overlapping the drain electrode.

2. The display panel of claim 1, wherein the thin film transistor is formed at a position adjacent to the sub pixel area.

3. The display panel of claim 2, wherein the drain electrode comprises a V shape in the sub pixel area.

4. The display panel of claim 1, wherein the first display substrate further comprises:
a gate line formed on the first base substrate and electrically connected to a gate electrode of the thin film transistor; and
a data line formed on the first base substrate and electrically connected to a source electrode of the thin film transistor, the data line extending perpendicularly to and insulated from the gate line.

5. The display panel of claim 4, wherein the main and sub pixel electrodes have cutouts that extend in a same direction as the gate line.

6. The display panel of claim 4, wherein the first display substrate further comprises:
a storage line formed between the main pixel electrode and the sub pixel electrode and extending in a direction that is substantially parallel to the gate line; and
a storage electrode branching from the storage line and overlapping the main pixel electrode and the sub pixel electrode.

7. The display panel of claim 6, wherein the storage electrode extends in a direction that is substantially parallel to the data line.

8. The display panel of claim 6, wherein the main pixel electrode and the sub pixel electrode are symmetrically positioned with respect to the storage line.

9. The display panel of claim 1, wherein the second display substrate further comprises:
a second base substrate; and
a common electrode formed on the second base substrate.

10. The display panel of claim 9, wherein the common electrode is partially removed to form an opening in the main pixel area and another opening in the sub pixel area.

11. The display panel of claim 10, wherein the openings have generally a V shape in each of the main and sub pixel areas.

12. The display panel of claim 9, wherein the drain electrode is aligned with the opening of the common electrode.

13. The display panel of claim 1, further comprising a liquid crystal layer interposed between the first display substrate and the second display substrate.

14. A display panel comprising:
a first display substrate; and
a second display substrate facing the first display substrate,
wherein the first display substrate comprises:
a first base substrate including a pixel area divided into a main pixel area and a sub pixel area adjacent to the main pixel area;
a first thin film transistor formed on the first base substrate, the first thin film transistor having a first drain electrode;
a main pixel electrode formed in the main pixel area and electrically connected to the first drain electrode;
a second thin film transistor formed on the first base substrate, the second thin film transistor having a second drain electrode; and
a sub pixel electrode formed in the sub pixel area, the sub pixel electrode being electrically insulated from the main pixel electrode and connected to the second drain electrode, the sub pixel electrode having a same shape as the main pixel electrode.

15. The display panel of claim 14, wherein the first display substrate further comprises:
a gate line formed on the first base substrate and electrically connected to gate electrodes of the first and second thin film transistors; and
a data line formed on the first base substrate and electrically connected to source electrodes of the first and second thin film transistors, the data line extending perpendicularly to and insulated from the gate line.

16. The display panel of claim 15, wherein the main pixel electrode and the sub pixel electrode have cutouts that extend in a direction of the gate line, and wherein the main pixel electrode and the sub pixel electrode are positioned symmetrically with respect to the gate line.

17. The display panel of claim 15, wherein the first display substrate further comprises:
a first storage line extending in a direction of the gate line and receiving a first storage voltage having a first polarity;
a first storage electrode branching from the first storage line and overlapping the main pixel electrode;
a second storage line extending in the direction of the gate line and receiving a second storage voltage having a second polarity opposite the first polarity; and
a second storage electrode branching from the second storage line and overlapping the sub pixel electrode.

18. The display panel of claim 17, wherein the first and second storage electrodes extend in a direction that is substantially parallel to the data line.

19. The display panel of claim 14, wherein the first display substrate further comprises:
a first gate line formed on the first base substrate and electrically connected to a first gate electrode of the first thin film transistor;
a second gate line formed on the first base substrate and electrically connected to a second gate electrode of the second thin film transistor; and
a data line electrically connected to a source electrode of the first and second thin film transistors, the data line extending substantially perpendicularly to and insulated from the first and second gate lines.

20. The display panel of claim 19, wherein the first display substrate further comprises:
a storage line formed between the main pixel electrode and the sub pixel electrode and extending in a direction that is substantially parallel to the first and second gate lines; and
a storage electrode branching from the storage line and overlapping the main pixel electrode and the sub pixel electrode.

21. The display panel of claim 20, wherein the main pixel electrode and the sub pixel electrode are positioned symmetrically with respect to the storage line.

22. The display panel of claim 14, wherein the second display substrate further comprises:
a second base substrate; and
a common electrode formed on the second base substrate.

23. The display panel of claim 22, wherein the common electrode is partially removed to form an opening in the main pixel area and another opening in the sub pixel area.

24. The display panel of claim 23, wherein the openings have a generally V shape in each of the main and sub pixel areas.

25. The display panel of claim 14, further comprising a liquid crystal layer interposed between the first display substrate and the second display substrate.
